(19) United States
(12) Patent Application Publication
(10) Pub. No.: US 2026/0134803 A1
(43) Pub. Date: May 14, 2026

(54) ELECTRONIC DEVICE AND CONTROLLING METHOD THEREOF

(71) Applicant: SAMSUNG ELECTRONICS CO., LTD., Suwon-si (KR)

(72) Inventors: Jinjoo CHUNG, Suwon-si (KR); Jaemoon LEE, Suwon-si (KR)

(73) Assignee: SAMSUNG ELECTRONICS CO., LTD., Suwon-si (KR)

(21) Appl. No.: 19/373,177

(22) Filed: Oct. 29, 2025

Related U.S. Application Data
(63) Continuation of application No. PCT/KR2025/014884, filed on Sep. 23, 2025.

(30) Foreign Application Priority Data
Nov. 8, 2024 (KR) 10-20240157832

(51) Int. Cl. G09G 3/00; G06F 3/0484

(52) U.S. Cl. CPC G09G 3/001; G06F 3/0484; G09G 2354/00

(57) ABSTRACT

An electronic device may include: a display; memory storing instructions; and one or more processors including processing circuitry, wherein the instructions, when executed by the one or more processors individually or collectively, cause the electronic device to: based on receiving a user input for viewing a plurality of images while one image is displayed on the display, control the display to display a multi-view image including the plurality of images; based on receiving a user input for selecting a selected image of the plurality of images and viewing the selected image in a low vision mode, obtain a first image with an outline of an object in the selected image highlighted; obtain an output image including remaining images other than the first image among the plurality of images, and the first image with a border of the first image highlighted; and control the display to display the output image.

### CROSS-REFERENCE TO RELATED APPLICATIONS

This application is a bypass continuation of International Application No. PCT/KR2025/014884, filed on September 23, 2025, which is based on and claims priority to Korean Patent Application No. 10-2024-0157832, filed on November 8, 2024, in the Korean Intellectual Property Office, the disclosures of which are incorporated by reference herein in their entireties.

### BACKGROUND

### 1. Field

The present disclosure relates to an electronic device and a controlling method thereof, and more particularly to, an electronic device that provides a viewing mode for a person with low vision and a controlling method thereof.

### 2. Description of the Related Art

With the advancement of electronic technology, various types of electronic devices are being developed and distributed. In particular, display devices such as TVs and laptops are being developed in various forms.

In general, display devices such as TVs provide a low vision mode (or Relumino mode) to help visually impaired people with low vision.

According to an example of a low vision mode, an outline area can be highlighted with a specific color. The outline highlight function can help low vision people better understand the shape and movement of objects by highlighting the border area of an image.

### SUMMARY

According to an aspect of the disclosure, an electronic device may include: a display; memory storing instructions; and one or more processors including processing circuitry, wherein the instructions, when executed by the one or more processors individually or collectively, cause the electronic device to: based on receiving a user input for viewing a plurality of images while one image is displayed on the display, control the display to display a multi-view image including the plurality of images; based on receiving a user input for selecting a selected image of the plurality of images and viewing the selected image in a low vision mode, obtain a first image with an outline of an object in the selected image highlighted; obtain an output image including remaining images other than the first image among the plurality of images, and the first image with a border of the first image highlighted; and control the display to display the output image.

The instructions, when executed by the one or more processors individually or collectively, may further cause the electronic device to: identify highlighting information for highlighting the outline of the object in the first image; and highlight the border of the first image based on the highlighting information.

The highlighting information may include at least one of color, thickness, or style of the outline.

The instructions, when executed by the one or more processors individually or collectively, may further cause the electronic device to: highlight the border of the first image based on at least one of preset color, preset thickness, or preset style to highlight the border of the first image.

The instructions, when executed by the one or more processors individually or collectively, may further cause the electronic device to: obtain the output image by mixing the first image, a second image including the remaining images, and a third image including border information of the first image.

The instructions, when executed by the one or more processors individually or collectively, may further cause the electronic device to: identify highlighting information for highlighting the outline of the object in the first image; identify location information corresponding to the selected image in the multi-view image; and obtain the third image based on the highlighting information and the location information corresponding to the selected image.

The instructions, when executed by the one or more processors individually or collectively, may further cause the electronic device to: based on receiving a user input for viewing the first image in full screen, control the display to display the first image in full screen; and based on receiving a user input for selecting a multi-view mode, control the display to display the multi-view image in the low vision mode. The multi-view image in the low vision mode may highlight outlines of objects in each of the plurality of images, and borders of each of the plurality of images.

The instructions, when executed by the one or more processors individually or collectively, may further cause the electronic device to: control the display to display a Picture in Picture (PIP) image including a window of a preset size in a partial area of the display; and based on receiving a user input for viewing in the low vision mode, highlight a border of the window of the preset size.

The instructions, when executed by the one or more processors individually or collectively, may further cause the electronic device to: based on the low vision mode being executed while the multi-view image is displayed, display a user interface (UI) for border setting on the display. The UI may include a menu for setting at least one of border highlight, border color, border thickness, or border style.

According to an aspect of the disclosure, a method of controlling an electronic device, may include: based on receiving a user input for viewing a plurality of images while one image is displayed, displaying a multi-view image including the plurality of images; based on receiving a user input for selecting a selected image of the plurality of images and viewing the selected image in a low vision mode, obtaining a first image with an outline of an object in the selected image highlighted; obtaining an output image including remaining images other than the first image among the plurality of images, and the first image with a border of the first image highlighted; and displaying the output image.

The method may further include: identifying highlighting information for highlighting the outline of the object in the first image; and highlighting the border of the first image based on the highlighting information.

The highlighting information may include at least one of color, thickness or style of the outline.

The method may further include: highlighting the border of the first image based on at least one of preset color, preset thickness, or preset style to highlight the border of the first image.

The method may further include: obtaining the output image by mixing the first image, a second image including the remaining images, and a third image including border information of the first image.

The method may further include: identifying highlighting information for highlighting the outline of the object in the first image; identifying location information corresponding to the selected image in the multi-view image; and obtaining the third image based on the highlighting information and the location information corresponding to the selected image.

The method may further include: based on receiving a user input for viewing the first image in full screen, displaying the first image in full screen; and based on receiving a user input for selecting a multi-view mode, displaying the multi-view image in the low vision mode. The multi-view image in the low vision mode may highlight outlines of objects in each of the plurality of images, and borders of each of the plurality of images.

The method may further include: displaying a Picture in Picture (PIP) image including a window of a preset size in a partial area of a display; and based on receiving a user input for viewing in the low vision mode, highlighting a border of the window of the preset size.

The method may further include: based on the low vision mode being executed while the multi-view image is displayed, displaying a user interface (UI) for border setting. The UI may include a menu for setting at least one of border highlight, border color, border thickness, or border style.

According to an aspect of the disclosure, a non-transitory computer-readable recording medium storing computer instructions that, when executed by one or more processors of an electronic device, individually or collectively, cause the electronic device to: based on receiving a user input for viewing a plurality of images while one image is displayed, display a multi-view image including the plurality of images; based on receiving a user input for selecting a selected image of the plurality of images and viewing the selected image in a low vision mode, obtain a first image with an outline of an object in the selected image highlighted; obtain an output image including remaining images other than the first image among the plurality of images, and the first image with a border of the first image highlighted; and display the output image.

The computer instructions, when executed by the one or more processors individually or collectively, may further cause the electronic device to: identify highlighting information for highlighting the outline of the object in the first image; and highlight the border of the first image based on the highlighting information.

### BRIEF DESCRIPTION OF THE DRAWING

The above and other aspects, features, and advantages of certain embodiments of the present disclosure will be more apparent from the following description taken in conjunction with the accompanying drawings, in which:

FIG. 1 is a view showing an operation of an electronic device according to one or more embodiments;

FIG. 2 is a block diagram showing configuration of an electronic device according to one or more embodiments;

FIG. 3 is a block diagram showing detailed configuration of an electronic device according to one or more embodiments;

FIG. 4 is a view showing a first image acquisition process of an electronic device according to one or more embodiments;

FIG. 5 is a view showing a first image processing process according to one or more embodiments;

FIG. 6 is a view showing a border highlight process of an image where a low vision mode is applied according to one or more embodiments;

FIG. 7 is a view showing a third image acquisition process including border information of a first image according to one or more embodiments;

FIG. 8 is a view showing an output image acquisition process of an electronic device according to one or more embodiments;

FIG. 9 is a view showing a multi-view image display process of an image where a low vision mode is applied according to one or more embodiments;

FIG. 10 is a view showing a PIP image display process of an electronic device according to one or more embodiments;

FIG. 11 is a view showing a PIP image display process of an electronic device according to one or more embodiments;

FIG. 12 is a view showing a border setting UI of an electronic device according to one or more embodiments;

FIG. 13 is a view showing an operation process of an electronic device according to one or more embodiments; and

FIG. 14 is a view showing an overall operation process of an electronic device according to one or more embodiments.

### DETAILED DESCRIPTION

General terms that are currently widely used are selected as the terms used in embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, and in this case, the meanings of such terms are mentioned in detail in corresponding descriptions of the disclosure. Therefore, the terms used in the embodiments of the disclosure need to be defined on the basis of the meanings of the terms and the contents throughout the disclosure rather than simple names of the terms.

In the disclosure, the expressions “have”, “may have”, “include” or “may include” used herein indicate existence of corresponding features (e.g., elements such as numeric values, functions, operations, or components), but do not exclude presence of additional features.

An expression, “at least one of A or/and B” may indicate either “A or B”, or “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor except for a ‘module’ or a ‘unit’ that needs to be implemented as specific hardware.

In this specification, the term ‘user’ may refer to a person using an electronic device or a device used by that person.

Hereinafter, one or more embodiments of the present disclosure will be described in detail with reference to the accompanying drawings.

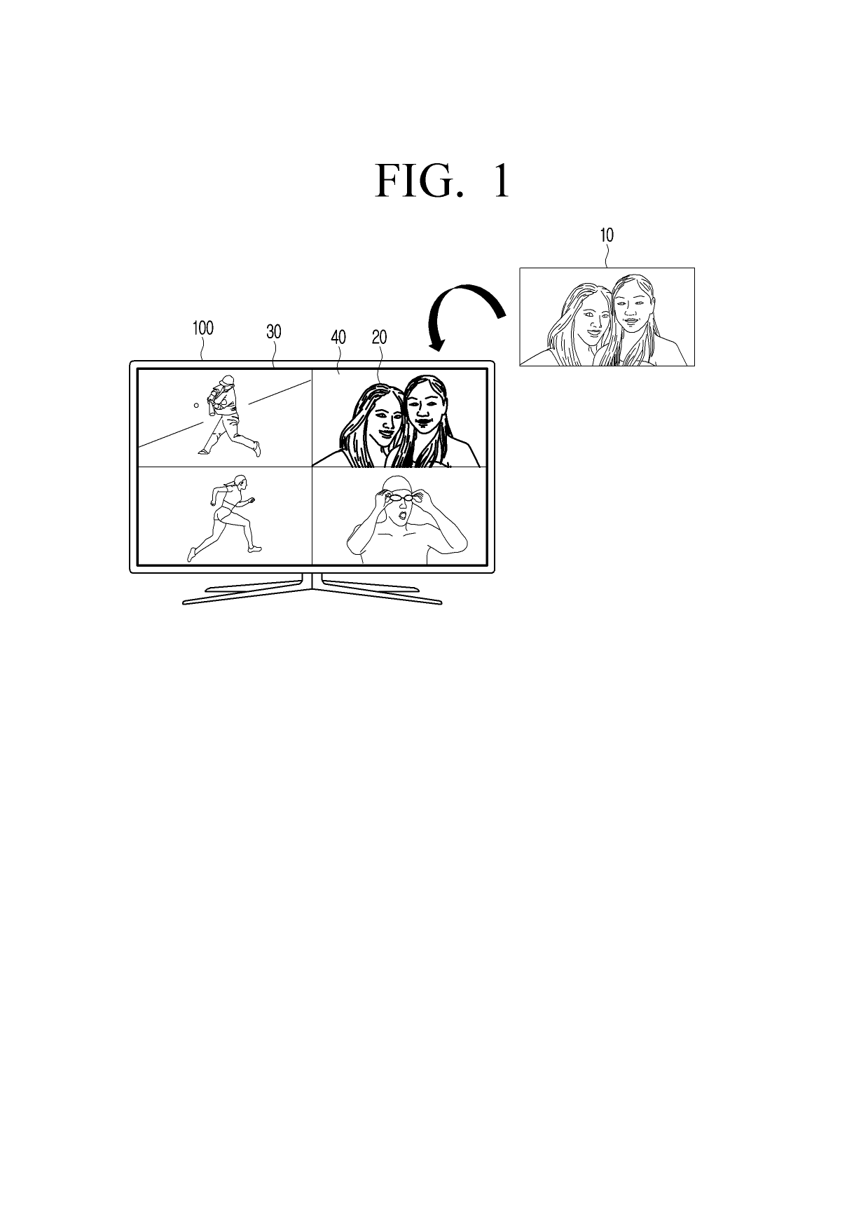

FIG. 1 is a view showing an operation of an electronic device according to one or more embodiments.

According to one or more embodiments, the electronic device 100 may provide an image in which a low vision mode (or a Relumino mode) is applied. Here, the electronic device 100 may be implemented as various types of electronic devices such as a smart TV, a monitor, a kiosk, a tablet PC, an electronic picture frame, a mobile phone, a large format display (LFD), a digital signage, a digital information display (DID), a video wall, a projector display, etc. However, in some cases, the electronic device 100 may be implemented as an image processing device (e.g., a set-top box, one connected box) that is connected to the electronic device and provides an image.

The low vision mode may be a special function designed for users who have difficulty in enjoying the visual experience. In the low vision mode, various auxiliary functions such as highlighting the outline of an object included in an image, adjusting text size and font, adjusting brightness and contrast, adjusting color, and providing voice guidance and commentary may be provided.

The low vision mode may generally include a user-defined function that allows the user to set and manage preferred settings. In general, low vision users tend to prefer images in which detailed expressions inside an object are omitted and the outlines of the objects are more clearly highlighted. Accordingly, the electronic device 100 may perform an outline highlight process 20 to highlight the outlines of objects included in an input image 10, as illustrated in FIG. 1.

According to one or more embodiments, the electronic device 100 may receive a plurality of images from at least one input device, and provide a multi-view image including the plurality of images.

For example, when the electronic device 100 receives a user input corresponding to a multi-view mode for viewing a plurality of images from a user while displaying one image through a display, the electronic device 100 may provide a multi-view image including the plurality of images.

The multi-view image may be an image that provides a plurality of images simultaneously on a single screen. The multi-view image may be an image that provides a plurality of images simultaneously by displaying one image in each of a plurality of areas divided according to a preset size.

For example, when four images are received from at least one input device, as illustrated in FIG. 1, the electronic device 100 may provide the plurality of images simultaneously by displaying one image among the plurality of images in each of four equally divided areas. The multi-view image is not limited thereto, and may be referred to in various ways, such as a multi-screen image, a split-screen image, a simultaneous screen playback image, etc., but in the present disclosure, it will be collectively referred to as a multi-view image.

According to one or more embodiments, the electronic device 100 may set at least one image among a plurality of images displayed as multi-view images to a low vision mode, and provide the image set to the low vision mode and the remaining images simultaneously.

Referring to FIG. 1, the electronic device 100 may provide a plurality of images including an input image 10 as a multi-view image 30. The electronic device 100 may receive a user input for applying a low vision mode to an image selected by the user from among the plurality of images. The electronic device 100 may perform the outline highlight process 20 for an object included in the selected image to provide an image 40 to which a low vision mode is applied.

However, a user who watches a multi-view image including an image set to a low vision mode may experience a problem of reduced image visibility because the boundaries of each image are not clearly displayed.

The visibility of an image refers to the degree to which a user watching multiple images can clearly recognize the image while watching the image, and may be affected by various visual elements such as the color, contrast, and brightness of the image. If the background color, brightness, or other visual characteristics of an image placed adjacent to an image set in low vision mode are similar, a user with low vision may experience difficulty in viewing the image set in low vision mode.

Hereinafter, with reference to the drawings, various embodiments will be described in which an electronic device 100 enhances the visibility of an image by highlighting the border of an image set to a low vision mode among a plurality of images displayed in multi-view.

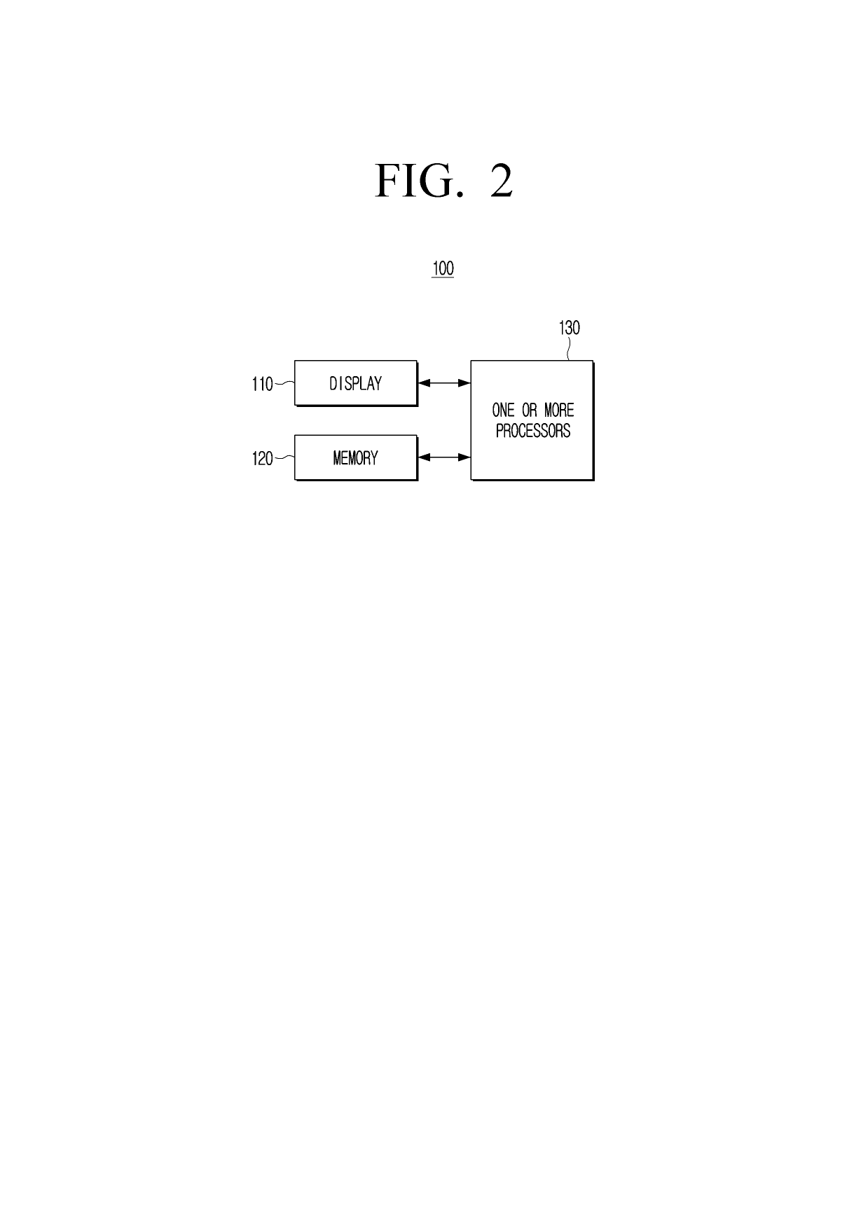

FIG. 2 is a block diagram showing configuration of an electronic device according to one or more embodiments.

According to FIG. 2, the electronic device 100 includes a display 110, memory 120, and one or more processors 130. However, the present disclosure is not limited thereto, and the electronic device 100 may be implemented in a form in which some components are excluded, or may be implemented in a form in which other components are further included.

The display 110 is configured to provide a user with a plurality of input images received from an input device. The display 110 may be implemented as a display including a self-light emitting device or a display including a non-light emitting device and a backlight. For example, the display 110 may be implemented as various types of displays such as liquid crystal display (LCD), organic light emitting diodes (OLED) display, Light Emitting Diodes (LED), micro LED, Mini LED, Plasma Display Panel (PDP), Quantum dot (QD) display, quantum dot light-emitting diode (QLED) display, and the like. The display 110 may also include a driving circuit, a backlight unit, and the like, which may be implemented in the form of amorphous silicon thin film transistor (a-si TFTs), low temperature poly silicon (LTPS) TFTs, organic TFTs (OTFTs), and the like.

The memory 120 may store at least one command, data, program, etc. required for the operation of the electronic device 100. For example, the memory 120 may store outline highlight process information and location information corresponding to a selected image.

The memory 120 may be implemented as a memory embedded in the electronic device 100 or as a memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100.

The memory embedded in the electronic device 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)).

The memory 120 may be implemented as a single memory that stores data generated from various operations according to the present disclosure, but is not limited thereto, and the memory 120 may be implemented to include multiple memories that each store different types of data or each store data generated at different stages.

The one or more processors 130 control the overall operations of the electronic device 100. Specifically, the one or more processors 130 may be connected to each component of the electronic device 100 to control the overall operations of the electronic device 100. For example, the one or more processors 130 may be electrically connected to the display 110 and the memory 120 to control the overall operations of the electronic device 100. The one or more processors 130 may include processing circuitry and may be composed of one or more processors.

The one or more processors 130 may perform the operations of the electronic device 100 according to various embodiments by executing at least one instruction stored in the memory 120.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or any combination of the other components of the electronic device, and may perform communication-related operations or data processing. The one or more processors 130 may execute at least one program or instruction stored in the memory. For example, the one or more processors may perform a method according to one or more embodiments by executing at least one instruction stored in the memory.

When a method according to one or more embodiments includes a plurality of operations, the plurality of operations may be performed by one processor or by a plurality of processors. For example, when a first operation, a second operation, and a third operation are performed by the method according to one or more embodiments, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 130 may be implemented as a single core processor including a single core or as one or more multicore processors including a plurality of cores (e.g., homogeneous multicore or heterogeneous multicore). When the one or more processors 130 are implemented as a multicore processor, each of the plurality of cores included in the multicore processor may include internal memory of the processor such as cache memory and an on-chip memory, and a common cache shared by the plurality of cores may be included in the multicore processor. Each of the plurality of cores (or some of the plurality of cores) included in the multicore processor may independently read and perform program instructions to implement the method according to one or more embodiments, or all (or some) of the plurality of cores may be coupled to read and perform program instructions to implement the method according to one or more embodiments.

When a method according to one or more embodiments includes a plurality of operations, the plurality of operations may be performed by one core of a plurality of cores included in a multi-core processor, or may be performed by a plurality of cores. For example, when a first operation, a second operation, and a third operation are performed by a method according to one or more embodiments, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the core is not limited to the embodiments of the present disclosure. Hereinafter, the one or more processors 130 will be referred to as the processor 130 for convenience of explanation.

According to one or more embodiments, when a user input for viewing a plurality of images is received while one image is displayed through the display 110, the processor 130 may control the display 110 to display a multi-view image including the plurality of images.

According to one or more embodiments, when a user input for selecting one image among a plurality of images and viewing the selected image in a low vision mode, the processor 130 may obtain a first image in which the outline of an object included in the selected image is highlighted.

According to one or more embodiments, the processor 130 may receive a user input for selecting one of a plurality of images included in a multi-view image from a controller or a mobile device connected to the electronic device 100 via a wired or wireless connection. The processor 130 may receive a user input for viewing the image selected by the user in a low vision mode.

The first image may be an image in which the outline of an object included in the image is highlighted according to a user setting based on a user input for viewing in a low vision mode. For example, the first image may be an image in which the outline of an entire object is highlighted for the entire image included in a multi-view image including a plurality of images. For example, the first image may be an image in which the outline of an object is highlighted only for an image selected by the user among the plurality of images.

According to one or more embodiments, the processor 130 may obtain an output image including the remaining images excluding the first image among the plurality of images and the first image, and the border of the first image is highlighted.

The output image may be an image that includes both an image where the low vision mode is applied and an image where the low vision mode is not applied. The image where the low vision mode is applied may be an image in which the outline of an object included in the corresponding image highlighted. The output image may be an image in which the border of only the image with the low vision mode applied is highlighted.

According to one or more embodiments, the processor 130 may control the display to display the output image on the display.

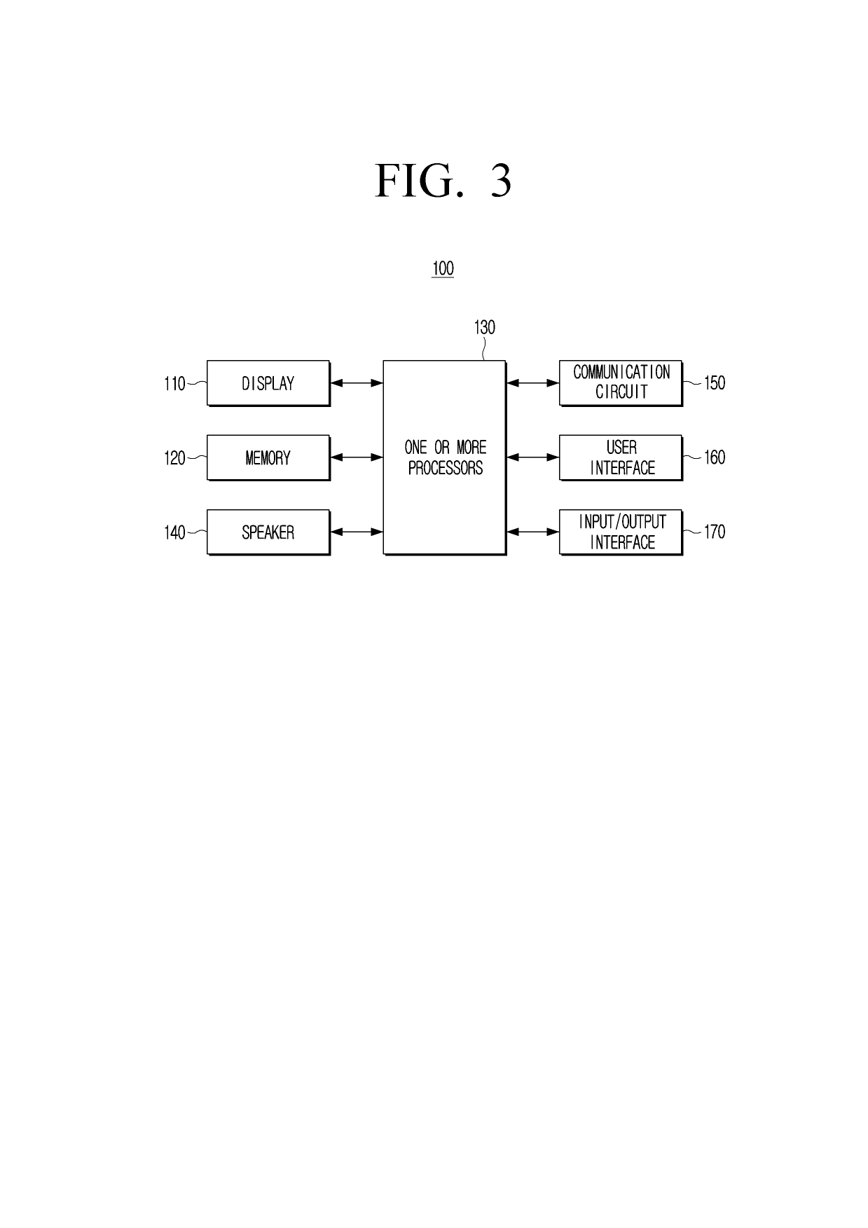

FIG. 3 is a block diagram showing detailed configuration of an electronic device according to one or more embodiments.

According to FIG. 3, the electronic device 100 includes the display 110, the memory 120, the one or more processors 130, a speaker 140, a communication circuit 150, a user interface 160, and an input/output interface 170. The detailed description of the configurations illustrated in FIG. 3 that overlap with the configurations illustrated in FIG. 2 will be omitted.

The speaker 140 may convert and amplify a digital sound signal processed by the processor 130 into an analog sound signal and output the signal. For example, the speaker 140 may include at least one speaker unit, a D/A converter, an audio amplifier, etc. that can output at least one channel. For example, the speaker 140 may output various notifications, messages, information, etc. related to feedback from the processor 130.

The communication circuit 150 may include a wired or wireless input/output interface (or input/output terminal) according to various standards. The communication circuit 150 may be configured to perform communication with various types of external devices according to various types of communication methods. The communication circuit 150 may include a wireless communication module or a wired communication module. Here, each communication module may be implemented in the form of at least one hardware chip.

The communication circuit 150 may include various interfaces such as High Definition Multimedia Interface (HDMI), Mobile High-Definition Link (MHL), Universal Serial Bus (USB), Display Port (DP), Thunderbolt, Video Graphics Array (VGA) port, RGB port, D-subminiature (D-SUB), Digital Visual Interface (DVI), Bluetooth, Zigbee, wired/wireless Local Area Network (LAN), Wide Area Network (WAN), Ethernet, IEEE 1394, Audio Engineering Society/European Broadcasting Union (AES/EBU), optical, coaxial, etc.

The user interface 160 may be implemented as a device such as a button, a touch pad, a mouse, and a keyboard, or may be implemented as a touch screen that can also perform the display function and the manipulation input function described above.

According to one or more embodiments, the user interface 160 may receive a user command for selecting a low vision mode, a user command for selecting the thickness and/or color of an outline (or edge) in the low vision mode, etc.

The input/output interface 170 may be any one of the interfaces of High Definition Multimedia Interface (HDMI), Mobile High-Definition Link (MHL), Universal Serial Bus (USB), Display Port (DP), Thunderbolt, Video Graphics Array (VGA) port, RGB port, D-subminiature (D-SUB), and Digital Visual Interface (DVI). The input/output interface 170 may input/output at least one of an audio signal or a video signal. Depending on the implementation example, the input/output interface 170 may include a port that inputs/outputs only audio signals and a port that inputs/outputs only video signals as separate ports, or may be implemented as a single port that inputs/outputs both audio signals and video signals.

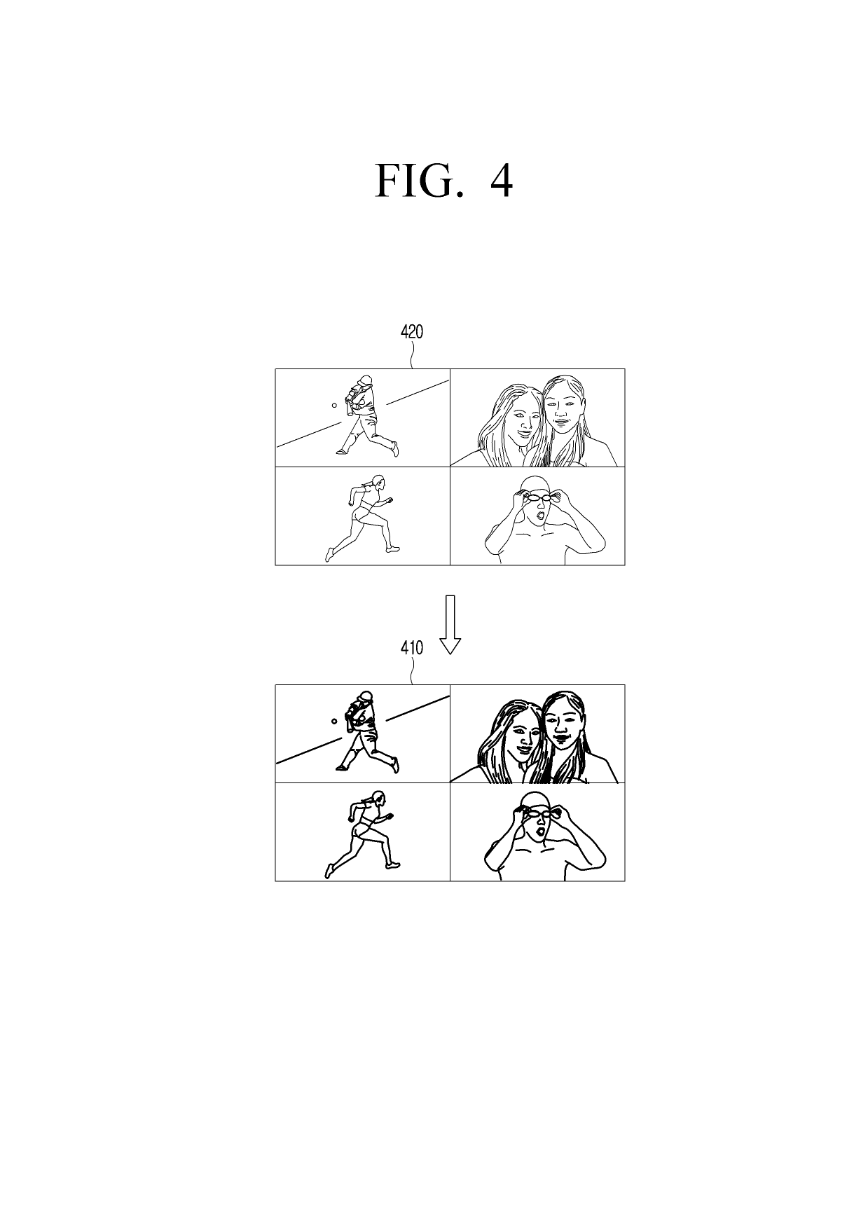

FIG. 4 is a view showing a first image acquisition process of an electronic device according to one or more embodiments.

According to one or more embodiments, the electronic device 100 may obtain a first image 410 in which the outline of an object included in the image is highlighted. The electronic device 100 may obtain a first image in which a low vision mode is applied for a selected image or the entire images among a plurality of images.

According to one or more embodiments, the electronic device 100 may set a multi-view image including a plurality of images as one frame. The electronic device 100 may adjust the scale of each of the plurality of images to place the plurality of images in each of the divided areas. Here, one frame may be a frame in which a plurality of images are placed in each of the divided areas and displayed as one image as a whole. For example, the electronic device 100 may place four images in each of the four divided areas to obtain one multi-view image including all of the four images.

According to one or more embodiments, the electronic device 100 may obtain the first image 410 by applying the low vision mode to the entirety of a multi-view image 420. The electronic device 100 may obtain the first image 410 in which the outline of each of a plurality of objects included in the multi-view image 420 is highlighted.

According to one or more embodiments, the electronic device 100 may identify a plurality of objects included in the multi-view image 420, and obtain the first image 410 by highlighting the outlines of the identified objects. As an example, the electronic device 100 may recognize the outlines of the objects and the boundaries between the objects through computer vision technology or an artificial intelligence model and perform an outline highlight process.

According to one or more embodiments, the electronic device 100 may obtain the first image through an overlay method of mixing an image that displays only the outline of an object in the multi-view image 420. In other words, the first image may be obtained by mixing an image layer including the multi-view image 420 and an image layer in which the outline of an object is highlighted at the same position.

In FIG. 4, it is assumed that there are four images. Referring to FIG. 4, the electronic device 100 may obtain the multi-view image 420 in which a plurality of images received from at least one input device are set as one frame. The electronic device 100 may identify a plurality of objects included in the multi-view image 420, and obtain the first image 410 to which a low vision mode is applied by highlighting the outlines of the objects.

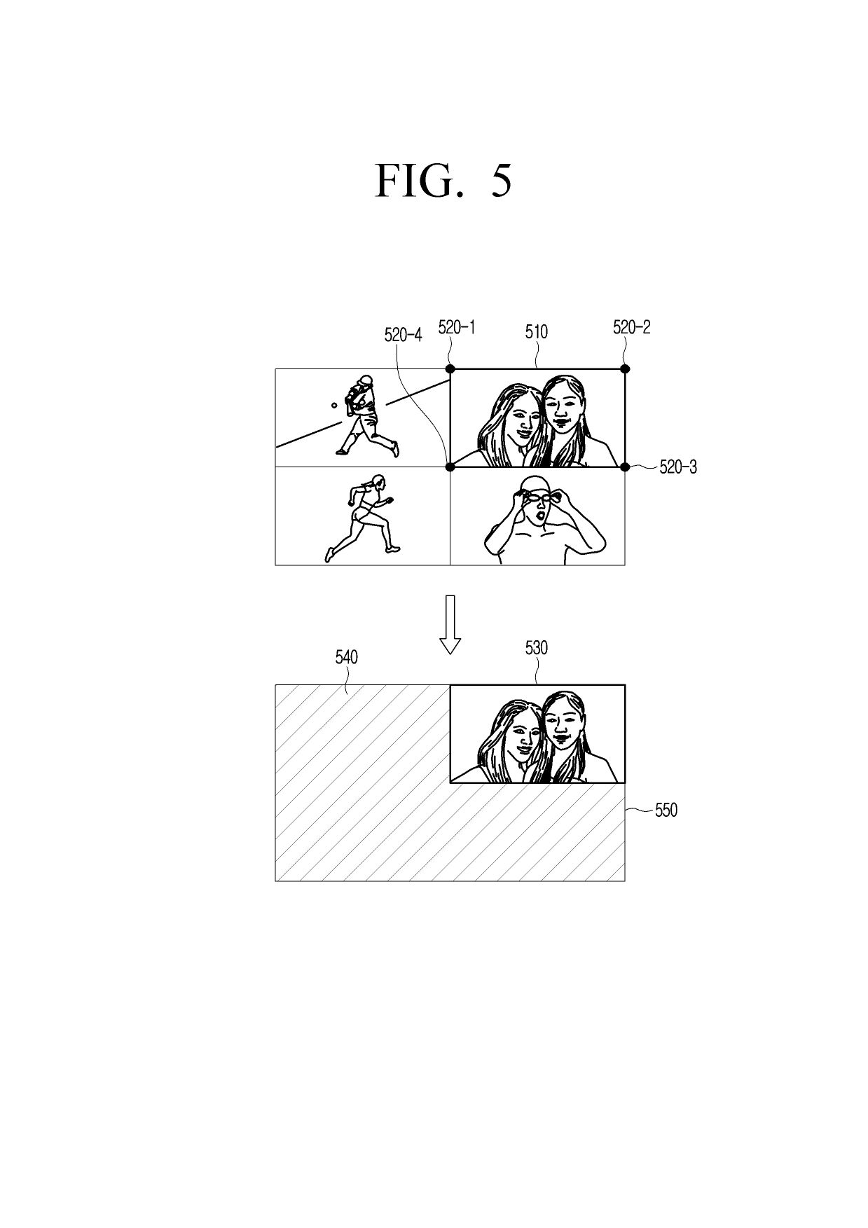

FIG. 5 is a view showing a first image processing process according to one or more embodiments.

According to one or more embodiments, when a user input for selecting one of a plurality of images is received, the electronic device 100 may obtain the first image in which the outline of an object included in the selected image is highlighted.

According to one or more embodiments, the electronic device 100 may identify location information corresponding to the selected image in the multi-view image 420. For example, the electronic device 100 may identify a pixel location corresponding to each vertex of the selected image. For example, the electronic device may identify pixel coordinates corresponding to each vertex of the selected image using the center of the multi-view image 420 as the origin.

Referring to FIG. 5, when a user input for selecting one of a plurality of images is received, the electronic device 100 may identify pixel coordinates (520-1, 520-2, 520-3, and 520-4) corresponding to each vertex of the selected image 510. The electronic device 100 may identify the selected image (510) and the area corresponding to the selected image by connecting each of the identified pixel coordinates.

According to one or more embodiments, the electronic device 100 may perform the outline highlight process only for the selected image 510 based on the pixel coordinates (520-1 to 520-4) corresponding to each vertex of the selected image 510.

Referring to FIG. 5, the electronic device 100 may identify the location of the selected image 510 based on the pixel coordinates (520-1 to 520-4) corresponding to each vertex of the selected image 510. The electronic device 100 may perform the outline highlight process only for the selected image 510 in the first image 410. A first image 550 may be an image in which the outline of an object included in all of the plurality of images is highlighted as described in FIG. 4, but may also be an image in which the outline is highlighted only for the selected image as described in FIG. 5. Hereinafter, for convenience of explanation, the first image 550 will be described as an image in which the outline of an object is highlighted only for the selected image 510. Accordingly, the first image 550 may include a first area 530 comprising the selected image 510, and a second area 540 that is empty or transparent corresponding to the images other than the selected image 510.

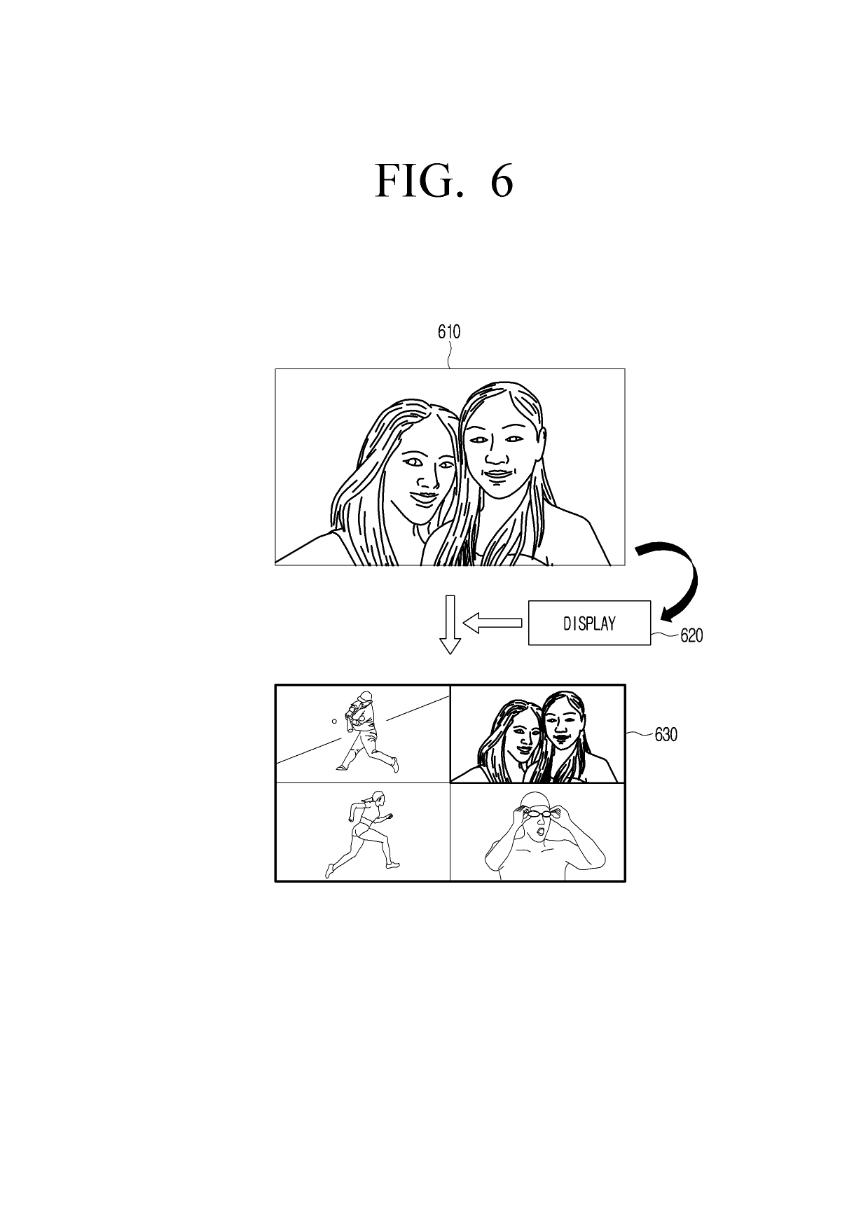

FIG. 6 is a view showing a border highlight process of an image where a low vision mode is applied according to one or more embodiments.

According to one or more embodiments, the electronic device 100 may identify highlight process information for the outline of an object in the first image, and highlight the border of the first image based on the identified highlight process information.

The outline highlight process information may be information including at least one of the outline color, thickness, or style. For example, the outline highlight process information may include information about the color, line thickness, and line style such as a solid line or a dotted line based on the pixel information of the outline.

According to one or more embodiments, the electronic device 100 may identify the outline highlight process information based on the pixel information of the first image. For example, the color and thickness information of the outline may be identified based on the R, G, and B pixel values of the outline displayed in the first image.

According to one or more embodiments, the electronic device 100 may identify the outline highlight process information based on the received user input. For example, when the user inputs a green color, 5 mm thickness, and solid line style for applying a low vision mode to the selected image based on a controller or a mobile device, the electronic device 100 may identify the outline highlight process information based on the user input.

According to one or more embodiments, the electronic device 100 may highlight the border of the first image with the same color, thickness, and style as the outline applied to the first image based on the identified highlight process information.

Referring to FIG. 6, the electronic device 100 may identify outline highlight process information 620 in a first image 610 to which the low vision mode is applied. The electronic device 100 may identify the color, thickness, or style information of the outline based on the outline highlight process information 620. The electronic device 100 may perform highlight process 630 on the border of the first image 610 based on the identified outline highlight process information 620.

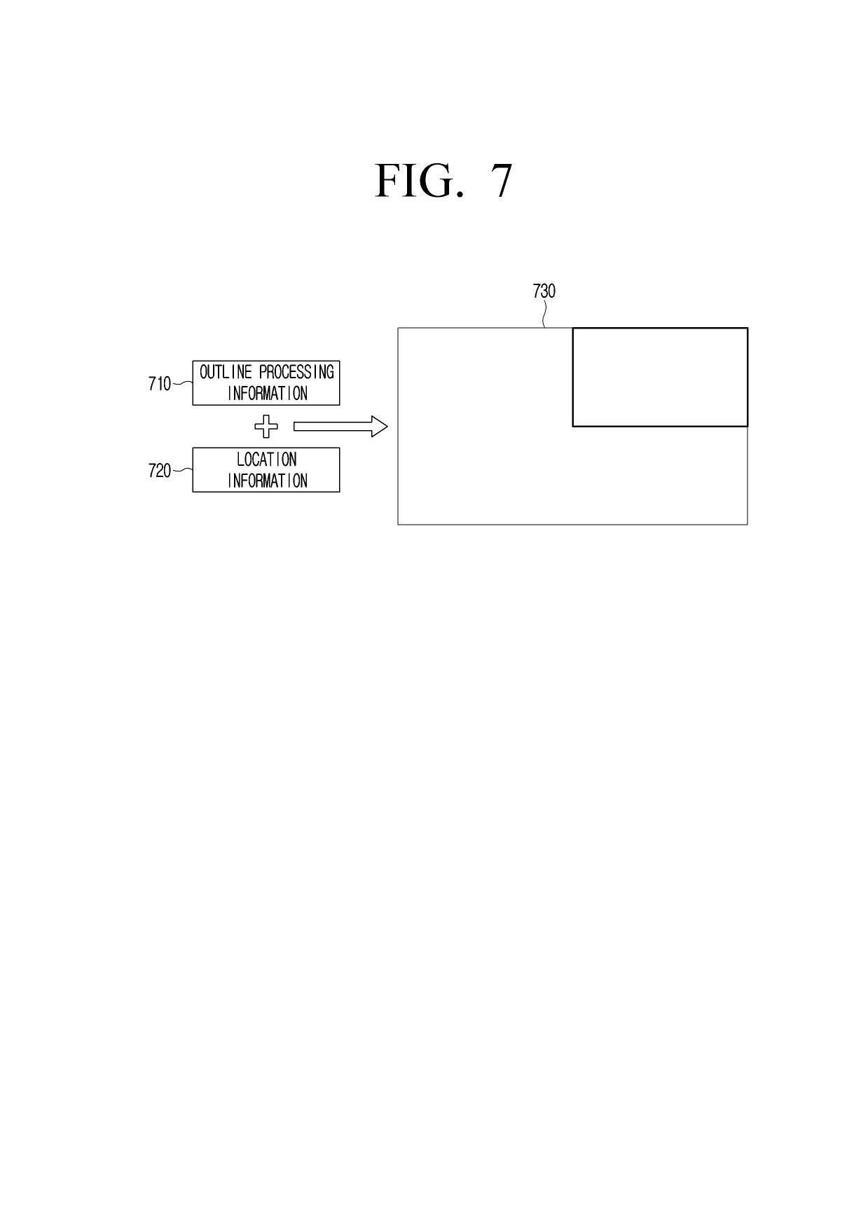

FIG. 7 is a view showing a third image acquisition process including border information of a first image according to one or more embodiments.

According to one or more embodiments, the electronic device 100 may identify highlight process information for the outline of an object in the first image, identify location information corresponding to an image selected from a multi-view image, and obtain a third image based on the identified outline highlight process information and the location information corresponding to the selected image.

According to one or more embodiments, the third image may be an image including border information corresponding to the selected image included in the first image. The third image may be an image in which the border surrounding the selected image is displayed based on a pixel location corresponding to the selected image. The border information may include highlight process information for the outline of an object included in the first image and information about border color, thickness, style, and location based on location information corresponding to the selected image.

Referring to FIG. 7, the electronic device 100 may identify color, thickness, and style information of a line to be displayed in the border based on highlight process information 710 for the outline. The electronic device 100 may identify location information 720 where the border will be displayed based on the pixel location for each vertex of the selected image. The electronic device 100 may obtain a third image 730 in which the border is displayed based on the identified highlight process information of the outline and the location information of the selected image.

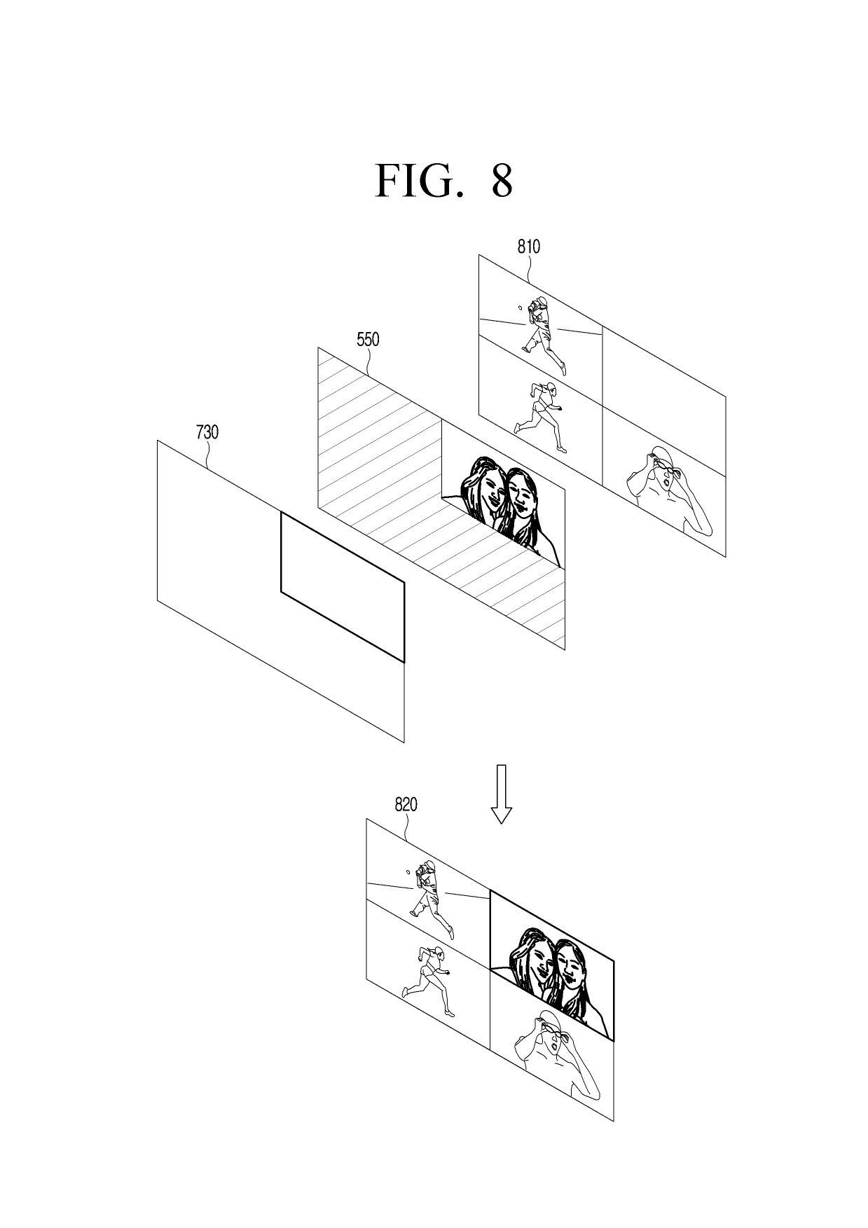

FIG. 8 is a view showing an output image acquisition process of an electronic device according to one or more embodiments.

According to one or more embodiments, the electronic device 100 may obtain an output image by mixing the first image 550, a second image 810 including the remaining images excluding the first image, and the third image 730 including the border information of the first image.

According to one or more embodiments, the electronic device 100 may mix the first image 550, the second image 810, and the third image 730 using alpha blending. The mixing operation may be a technology of combining two or more different frames to create one frame. The mixing operation may be referred to in various ways, such as frame mixing and layer mixing, but in this disclosure, it will be referred to as mixing.

For example, the electronic device 100 may obtain one output image based on alpha blending images (or alpha maps) corresponding to the first image 550, the second image 810, and the third image 730.

Here, the alpha blending refers to a method of displaying an image by overlapping another image on top of it in a way that creates a translucent effect, by assigning a new value called A (Alpha) to the RGB color values and blending the background RGB values with the overlaid RGB values. For example, the Alpha value is distinguished as a value of 0~255 or a value of 0.0~1.0, and 0 can mean completely transparent, and the opposite, 255 (or the highest value such as 1.0) can mean fully opaque. Alternatively, 0 can mean completely opaque, and the opposite, 255 (or the highest value such as 1.0) can mean fully transparent. For example, when 8 bits are allocated to the Alpha value and can express values from 0 to 255, the larger the value, the higher the ratio of the corresponding pixel, and the lower the value, the lower the ratio. For example, when mixing video (V) and graphics (G), the mixing operation may be expressed by an equation such as V*Alpha + G*(1-Alpah), V*(1-Alapha)+G*alpha or V*Alpha+G.

According to one or more embodiments, the mixing operation may be performed through at least one mixer, and the at least one mixer may be implemented as software and/or hardware. For example, the at least one mixer may include a first mixer that mixes the first image 550 and the second image 810, and a second mixer that mixes the output of the first mixer and the third image 730. The output of the first mixer may be an image in which the first image 550 and the second image 810 are mixed. However, the mixing order is not necessarily limited thereto. For example, the first image 550 and the third image 730 may be mixed first, and then the second image 810 may be mixed. For example, the first image 550, the second image 810, and the third image 730 may be mixed at once using one mixer.

According to one or more embodiments, the electronic device 100 may perform image processing on the first image 550, the second image 810, and the third image 730 at the same scale. The electronic device 100 may identify each image layer including each image and mix each image layer into one image.

Referring to FIG. 8, the electronic device 100 may mix the first image 550, the second image 810, and the third image 730 into one image so that each vertex of each image is located on the same line. The electronic device 100 may obtain an output image 820 in which only the outline of the image selected from the multi-view image is highlighted and the border surrounding the selected image is highlighted.

According to one or more embodiments, the electronic device 100 may display the output image 820 through the display 110.

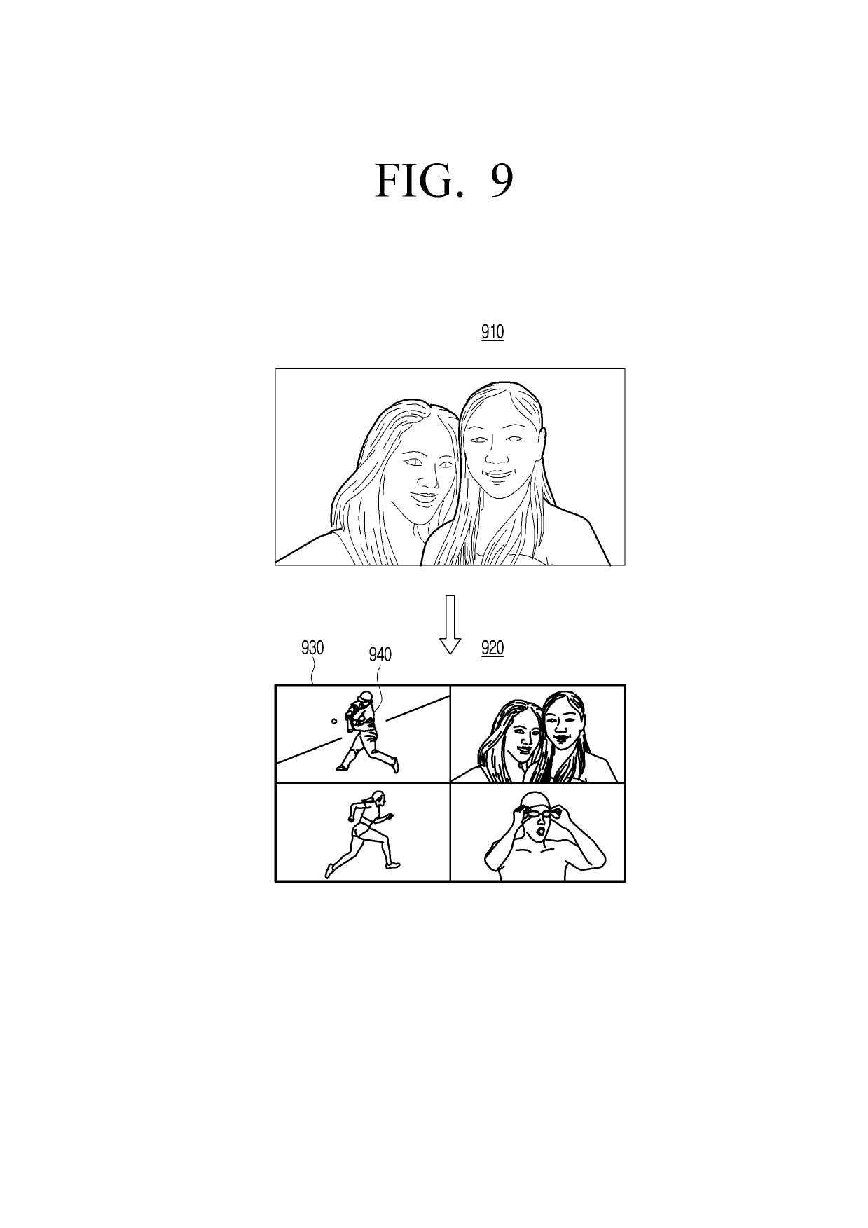

FIG. 9 is a view showing a multi-view image display process of an image where a low vision mode is applied according to one or more embodiments.

According to one or more embodiments, when a user input for viewing an image 910 to which a low vision mode is applied in full screen is received, the electronic device 100 may control the display 110 to display the image 910 to which a low vision mode is applied in full screen.

According to one or more embodiments, when a user input for selecting a multi-view mode is received, the electronic device 100 may control the display 110 to display a multi-view image 920 to which a low vision mode is applied.

The multi-view image to which the low vision mode is applied may be an image in which the outline of an object included in each of a plurality of images is highlighted and the border of each of the plurality of images is highlighted.

Referring to FIG. 9, the electronic device 100 may provide the image 910 to which the low vision mode is applied in full screen. When a user input for viewing in the multi-view mode is received from the user, the electronic device 100 may display the plurality of images in a multi-view image and display the plurality of images to which the low vision mode is applied through the display 110. In this case, the electronic device 100 may display an image in which an object 940 included in each of the plurality of images and a border 930 surrounding each of the plurality of images are highlighted through the display 110.

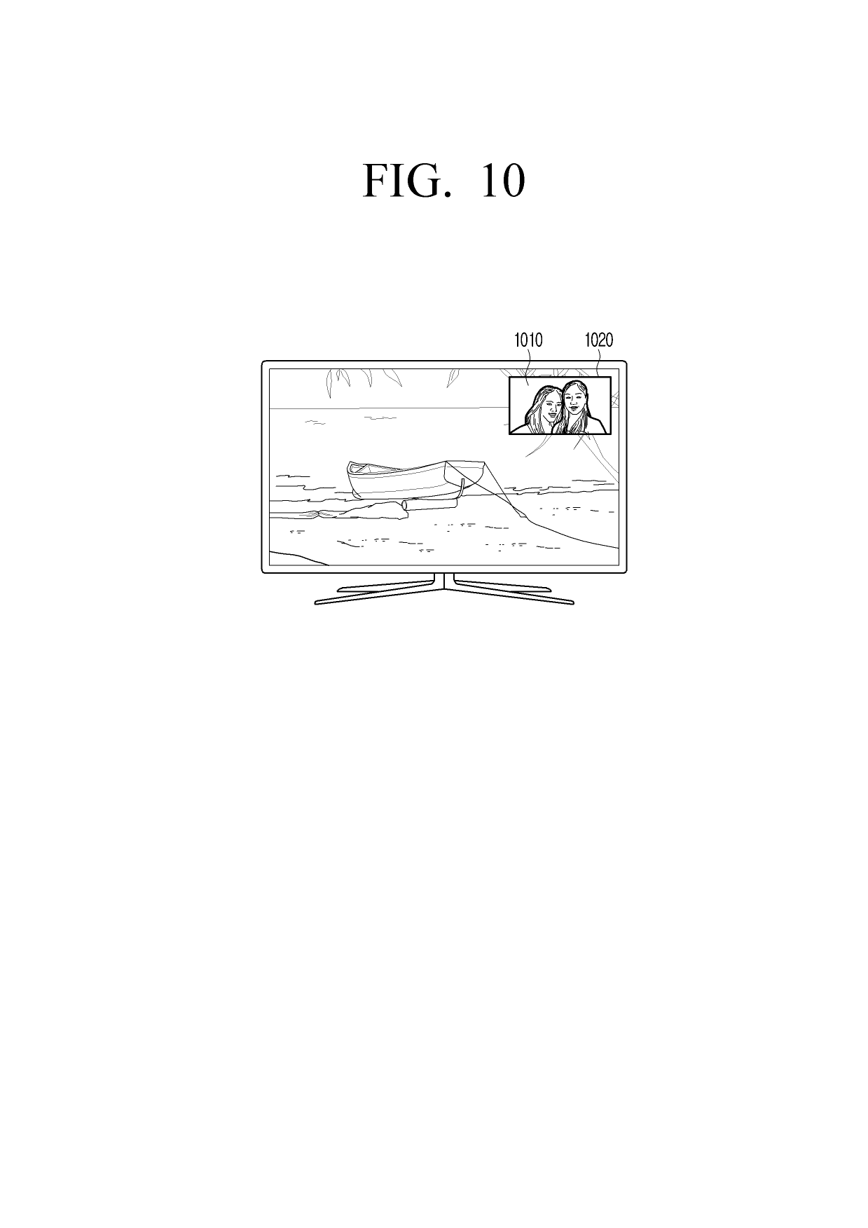

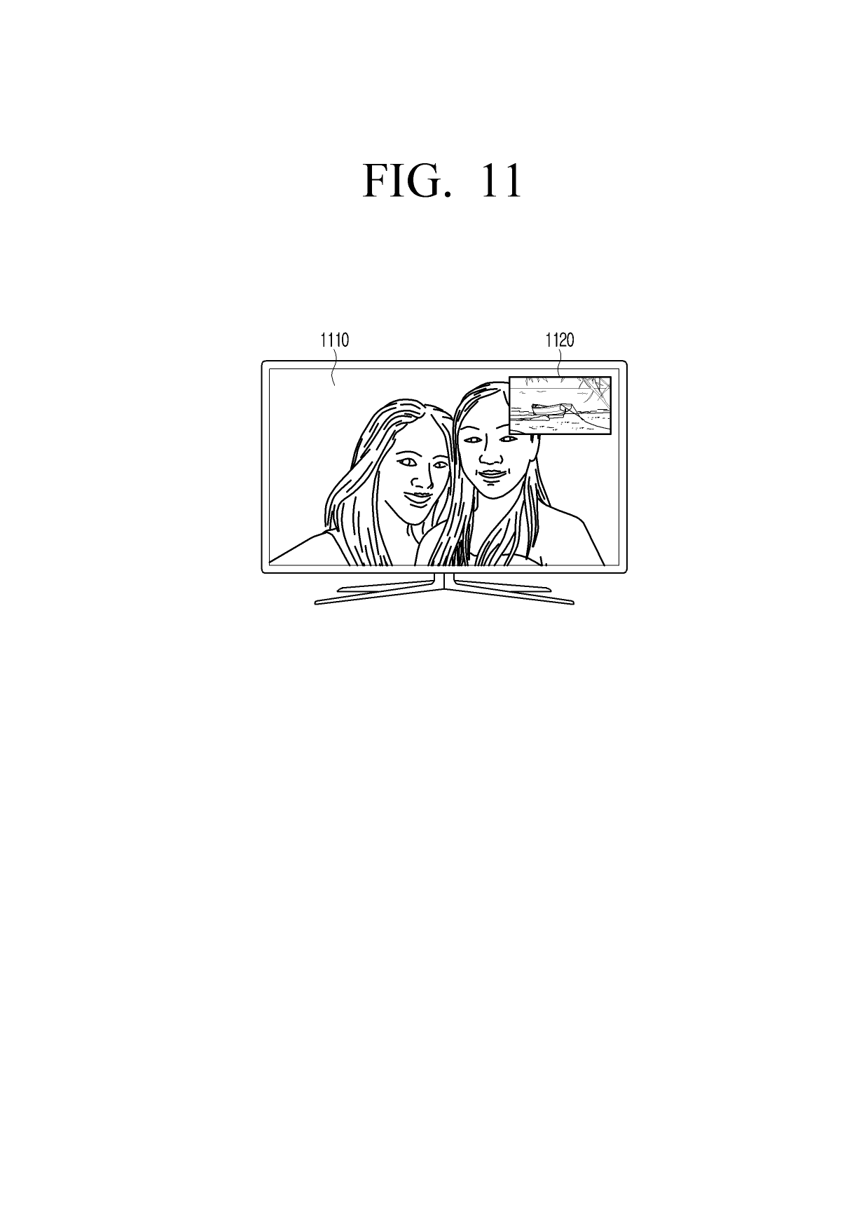

FIGS. 10 and 11 are views showing a PIP image display process of an electronic device according to one or more embodiments.

According to one or more embodiments, the electronic device 100 may control the display 110 to display a Picture in Picture (PIP) image including a window of a preset size in a partial area of the display screen.

According to one or more embodiments, when a user input for viewing in a low vision mode is received, the electronic device 100 may highlight the border of the window of the preset size.

The PIP image may be an image that provides the entire image and the image included in the window of the preset size by displaying the image of the preset size through the window in a partial area of the display screen while displaying the image in full screen. The PIP image may be an image that displays an image of a size smaller than the image displayed in the full screen in a partial area of the display screen.

According to one or more embodiments, the electronic device 100 may control the display 110 to display a PIP image that displays an image to which the low vision mode is applied in a window of a preset size while displaying an image to which the low vision mode is not applied in full screen.

Referring to FIG. 10, the electronic device 100 may provide a plurality of images by displaying a PIP image including a window of a preset size. The electronic device 100 may display an image 1010 to which the low vision mode is applied in a window of a preset size. In this case, the electronic device 100 may highlight the border 1020 of the window of the preset size based on outline highlight process information.

According to one or more embodiments, the electronic device 100 may control the display 110 to display a PIP image that displays an image to which the low vision mode is not applied in a window of a preset size while display an image 1110 to which the low vision mode is applied in full screen.

Referring to FIG. 11, the electronic device 100 may display the image 1110 to which the low vision mode is applied in full screen while displaying an image to which the low vision mode is not applied in a window of a preset size. In this case, the electronic device 100 may highlight the border 1120 of the window of the preset size based on the outline highlight process information, as illustrated in FIG. 10.

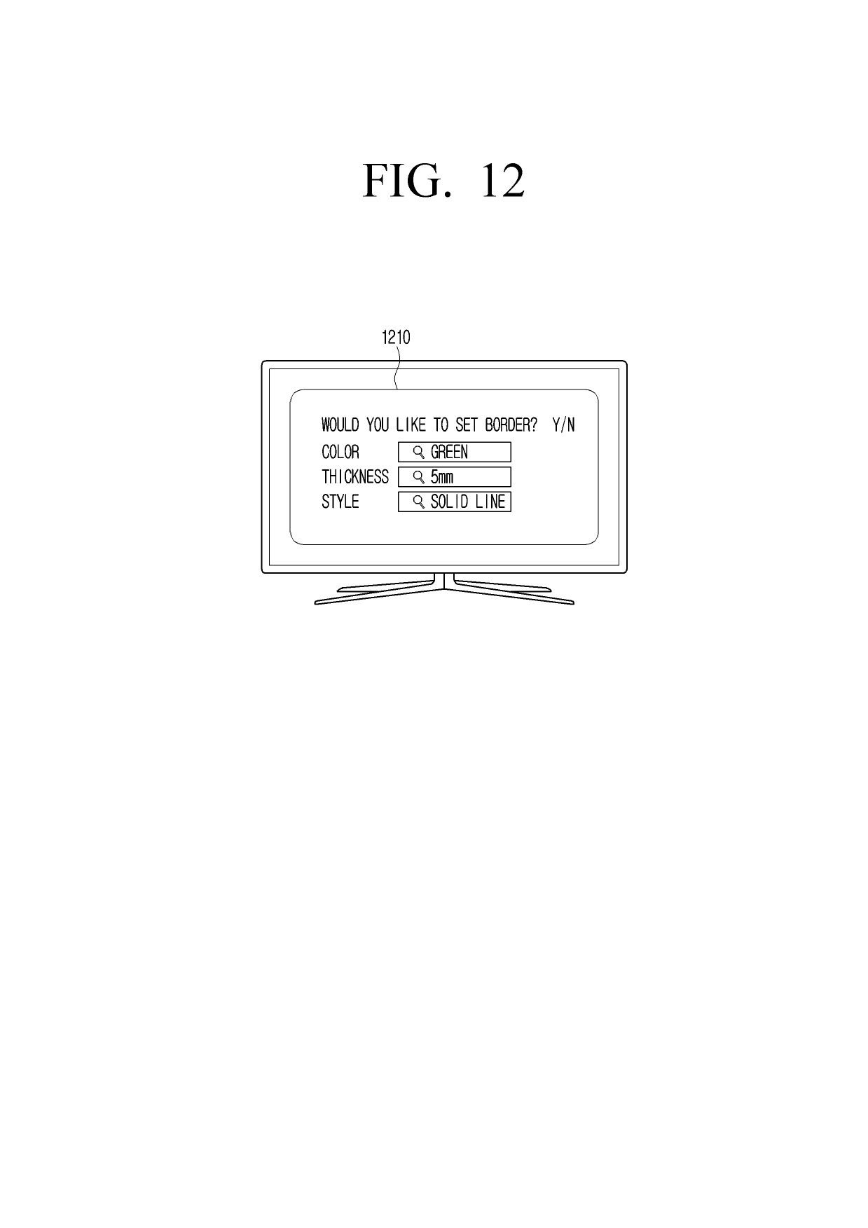

FIG. 12 is a view showing a border setting UI of an electronic device according to one or more embodiments.

According to one or more embodiments, the electronic device 100 may highlight the border of the first image based on at least one of a preset color, preset thickness, or preset style for highlighting the border of the first image. The electronic device 100 may highlight the border of the first image based on a color, thickness, and style that are different from the color, thickness, and style of the outline applied to the object of the first image.

According to one or more embodiments, when the low vision mode is executed while the multi-view image is provided, the electronic device 100 may display a User Interface (UI) 1210 for setting the border through the display 110.

The border setting UI 1210 may be a UI including a menu for setting at least one of border highlight, border thickness, border color, or border style.

Referring to FIG. 12, the electronic device 100 may display the border setting UI 1210 including a text phrase for whether to highlight the border, such as “Do you want to set the border? Y/N”, and a setting menu for setting the color, thickness, and style through the display 110.

The text phrase for whether to highlight the border and the settings menu included in the border setting UI 1210 are merely one embodiment, and they may be displayed with different phrases or different arrangements depending on the user settings.

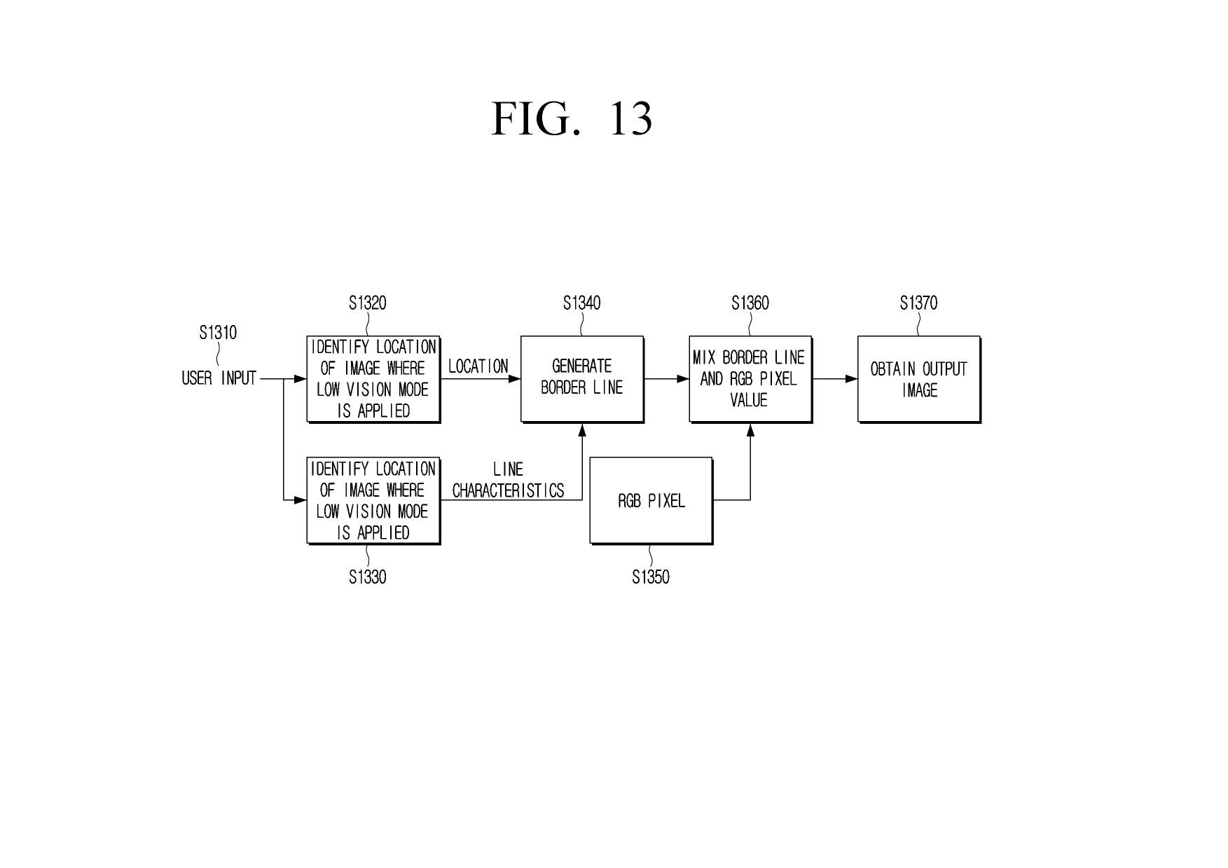

FIG. 13 is a view showing an operation process of an electronic device according to one or more embodiments.

Referring to FIG. 13, in operation S1310, the electronic device 100 may receive a user input for selecting one of a plurality of images from the user and viewing the selected image in a low vision mode.

In operation S1320, the electronic device 100 may identify a location of an image to which a low vision mode is applied based on a pixel location corresponding to the image to which the low vision mode is applied.

In operation S1330, the electronic device 100 may identify outline highlight process information based on an outline displayed on an object of the image to which the low vision mode is applied.

In operation S1340, the electronic device 100 may generate a border of the first image based on the outline highlight process information and the location information.

In operation S1350, the electronic device 100 may identify an RGB pixel corresponding to the border location.

In operation S1360, the electronic device 100 may highlight the border of the first image by mixing the generated border and the RGB pixel value.

In operation S1370, the electronic device 100 may obtain the first image in which the border of the first image is highlighted.

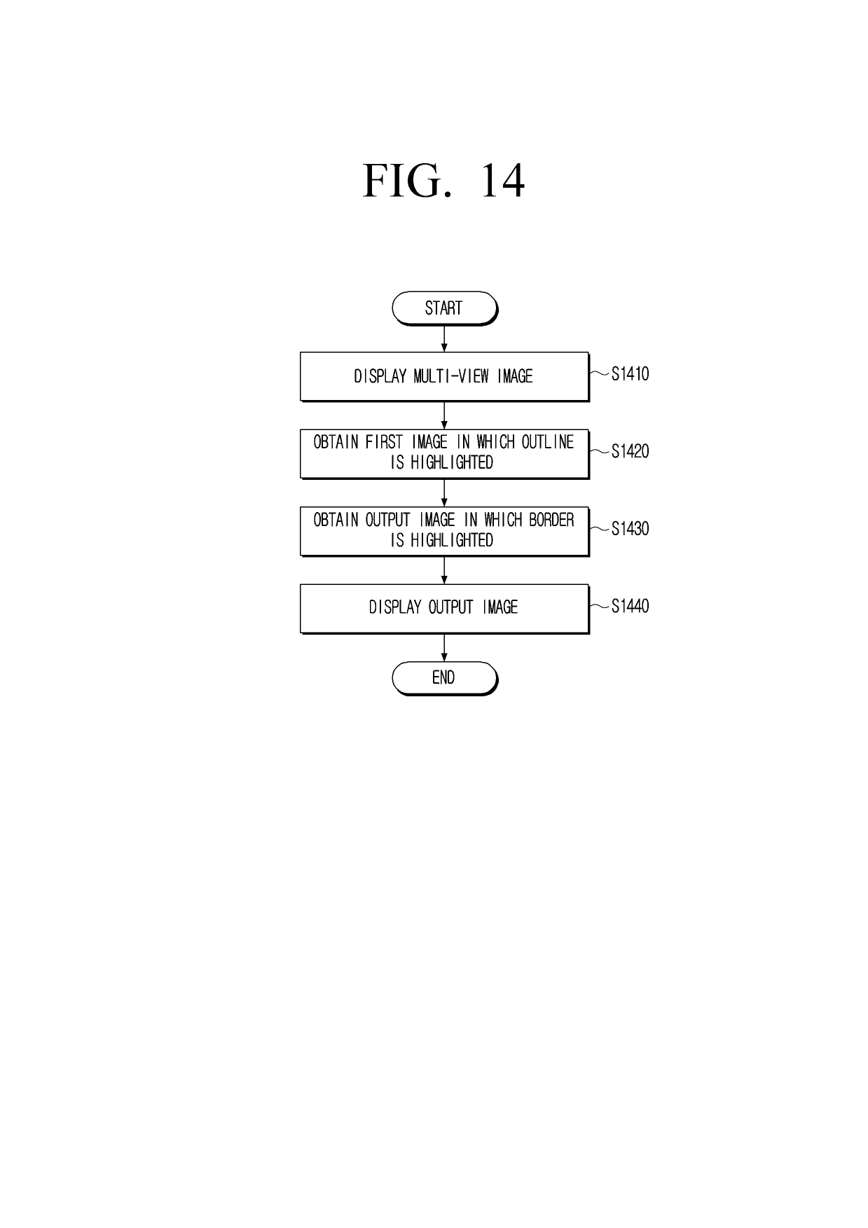

FIG. 14 is a view showing an overall operation process of an electronic device according to one or more embodiments.

Referring to FIG. 14, in operation S1410, the electronic device 100 may display a multi-view image including a plurality of images.

In operation S1420, when a user input for selecting one image among the plurality of images and viewing the selected image in a low vision mode is received, the electronic device 100 may obtain the first image in which the outline of an object included in the selected image is highlighted.

In operation S1430, the electronic device 100 may obtain an output image including the remaining images excluding the first image among the plurality of images and the first image, a border of the first image being highlighted.

In operation S1440, the electronic device 100 may display the output image through the display 110.

The specific method of obtaining the first image and obtaining the output image in which the border of the first image is highlighted has been described in detail through the above-described embodiments, so further description thereof will be omitted.

The controlling method described in FIG. 14 may be performed by the electronic device 100 having the configuration of FIG. 2 described above, but is not necessarily limited thereto, and may be performed by electronic devices having various configurations.

The various embodiments described above may be implemented as a single embodiment, or at least one embodiment may be combined with each other in whole or in part and implemented together in one device.

According to the various embodiments described above, the electronic device 100 may provide an image with higher visibility to a low vision person watching a multi-view image by highlighting the border of an image to which a low vision mode is applied.

Meanwhile, the various embodiments described above may be applied to the product as a single embodiment, or at least some of the contents may be implemented together in combination with other embodiments of the present disclosure.

The above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic device (e.g., electronic device 100) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to one or more embodiments, the method according to the various embodiments described above may be included and provided in a computer program product.

Specifically, a non-transitory readable storage medium or a computer program product storing computer instructions that cause operations to be performed may be provided. The operations include displaying a multi-view image including a plurality of images, based on a user input for selecting one of the plurality of images and viewing the selected image in a low vision mode being received, obtaining a first image in which the outline of an object included in the selected image is highlighted, obtaining an output image including the remaining images excluding the first image among the plurality of images and the first image, the border of the first image being highlighted, and displaying the output image.

The computer program product may be distributed in a form of a storage medium (e.g., a compact disc read only memory (CD-ROM)) that may be read by the machine or online through an application store (e.g., PlayStore^{TM}). In case of the online distribution, at least a portion of the computer program product may be at least temporarily stored in a storage medium such as a memory of a server of a manufacturer, a server of an application store, or a relay server or be temporarily generated.

Further, computer instructions or programs for performing the controlling method of an electronic device according to the above-described various embodiments may be stored in a non -transitory computer-readable medium. When being executed by a processor of a specific device, the computer instructions stored in such a non-transitory computer-readable medium allows the specific device to perform processing operations in the device according to the above-described various embodiments. The non-transitory computer-readable medium refers to a medium that stores data semi-permanently and can be read by a device, rather than a medium that stores data for a short period of time, such as registers, caches, and memories. Specific examples of the non-transitory computer-readable medium may include CD, DVD, hard disk, Blu-ray disk, USB, memory card, ROM, etc.

Although example embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. An electronic device comprising:
a display;
memory storing instructions; and
one or more processors comprising processing circuitry,
wherein the instructions, when executed by the one or more processors individually or collectively, cause the electronic device to:
based on receiving a user input for viewing a plurality of images while one image is displayed on the display, control the display to display a multi-view image comprising the plurality of images;
based on receiving a user input for selecting a selected image of the plurality of images and viewing the selected image in a low vision mode, obtain a first image with an outline of an object in the selected image highlighted;
obtain an output image comprising remaining images other than the first image among the plurality of images, and the first image with a border of the first image highlighted; and
control the display to display the output image.

2. The electronic device as claimed in claim 1, wherein the instructions, when executed by the one or more processors individually or collectively, further cause the electronic device to:
identify highlighting information for highlighting the outline of the object in the first image; and
highlight the border of the first image based on the highlighting information.

3. The electronic device as claimed in claim 2, wherein the highlighting information comprises at least one of color, thickness, or style of the outline.

4. The electronic device as claimed in claim 1, wherein the instructions, when executed by the one or more processors individually or collectively, further cause the electronic device to:
highlight the border of the first image based on at least one of preset color, preset thickness, or preset style to highlight the border of the first image.

5. The electronic device as claimed in claim 1, wherein the instructions, when executed by the one or more processors individually or collectively, further cause the electronic device to:
obtain the output image by mixing the first image, a second image comprising the remaining images, and a third image comprising border information of the first image.

6. The electronic device as claimed in claim 5, wherein the instructions, when executed by the one or more processors individually or collectively, further cause the electronic device to:
identify highlighting information for highlighting the outline of the object in the first image;
identify location information corresponding to the selected image in the multi-view image; and
obtain the third image based on the highlighting information and the location information corresponding to the selected image.

7. The electronic device as claimed in claim 1, wherein the instructions, when executed by the one or more processors individually or collectively, further cause the electronic device to:
based on receiving a user input for viewing the first image in full screen, control the display to display the first image in full screen; and
based on receiving a user input for selecting a multi-view mode, control the display to display the multi-view image in the low vision mode, and
wherein the multi-view image in the low vision mode highlights outlines of objects in each of the plurality of images, and borders of each of the plurality of images.

8. The electronic device as claimed in claim 1, wherein the instructions, when executed by the one or more processors individually or collectively, further cause the electronic device to:
control the display to display a Picture in Picture (PIP) image comprising a window of a preset size in a partial area of the display; and
based on receiving a user input for viewing in the low vision mode, highlight a border of the window of the preset size.

9. The electronic device as claimed in claim 1, wherein the instructions, when executed by the one or more processors individually or collectively, further cause the electronic device to:
based on the low vision mode being executed while the multi-view image is displayed, display a user interface (UI) for border setting on the display, and
wherein the UI comprises a menu for setting at least one of border highlight, border color, border thickness, or border style.

10. A method of controlling an electronic device, the method comprising:
based on receiving a user input for viewing a plurality of images while one image is displayed, displaying a multi-view image comprising the plurality of images;
based on receiving a user input for selecting a selected image of the plurality of images and viewing the selected image in a low vision mode, obtaining a first image with an outline of an object in the selected image highlighted;
obtaining an output image comprising remaining images other than the first image among the plurality of images, and the first image with a border of the first image highlighted; and
displaying the output image.

11. The method as claimed in claim 10, further comprising:
identifying highlighting information for highlighting the outline of the object in the first image; and
highlighting the border of the first image based on the highlighting information.

12. The method as claimed in claim 11, wherein the highlighting information comprises at least one of color, thickness or style of the outline.

13. The method as claimed in claim 10, further comprising:
highlighting the border of the first image based on at least one of preset color, preset thickness, or preset style to highlight the border of the first image.

14. The method as claimed in claim 10, further comprising:
obtaining the output image by mixing the first image, a second image comprising the remaining images, and a third image comprising border information of the first image.

15. The method as claimed in claim 14, further comprising:
identifying highlighting information for highlighting the outline of the object in the first image;
identifying location information corresponding to the selected image in the multi-view image; and
obtaining the third image based on the highlighting information and the location information corresponding to the selected image.

16. The method as claimed in claim 10, further comprising:
based on receiving a user input for viewing the first image in full screen, displaying the first image in full screen; and
based on receiving a user input for selecting a multi-view mode, displaying the multi-view image in the low vision mode,
wherein the multi-view image in the low vision mode highlights outlines of objects in each of the plurality of images, and borders of each of the plurality of images.

17. The method as claimed in claim 10, further comprising:
displaying a Picture in Picture (PIP) image comprising a window of a preset size in a partial area of a display; and
based on receiving a user input for viewing in the low vision mode, highlighting a border of the window of the preset size.

18. The method as claimed in claim 10, further comprising:
based on the low vision mode being executed while the multi-view image is displayed, displaying a user interface (UI) for border setting,
wherein the UI comprises a menu for setting at least one of border highlight, border color, border thickness, or border style.

19. A non-transitory computer-readable recording medium storing computer instructions that, when executed by one or more processors of an electronic device, individually or collectively, cause the electronic device to:
based on receiving a user input for viewing a plurality of images while one image is displayed, display a multi-view image comprising the plurality of images;
based on receiving a user input for selecting a selected image of the plurality of images and viewing the selected image in a low vision mode, obtain a first image with an outline of an object in the selected image highlighted;
obtain an output image comprising remaining images other than the first image among the plurality of images, and the first image with a border of the first image highlighted; and
display the output image.

20. The non-transitory computer-readable recording medium as claimed in claim 19, wherein the computer instructions, when executed by the one or more processors individually or collectively, further cause the electronic device to:
identify highlighting information for highlighting the outline of the object in the first image; and
highlight the border of the first image based on the highlighting information.
